(19) United States
(12) Patent Application Publication
(10) Pub. No.: US 2026/0321199 A1
(43) Pub. Date: Oct. 15, 2026

(54) PIXEL CIRCUIT AND DRIVING METHOD THEREFOR, DISPLAY PANEL AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Huijuan YANG, Beijing (CN); Haigang QING, Beijing (CN); Hongwei MA, Beijing (CN); Yi ZHANG, Beijing (CN); Xiaoqing SHU, Beijing (CN); Zhiwen CHU, Beijing (CN)

(21) Appl. No.: 18/837,821

(22) PCT Filed: Nov. 22, 2023
(86) PCT No.: PCT/CN2023/133275

§ 371 Date: Aug. 12, 2024

(51) Int. Cl. G09G 3/3225

(52) U.S. Cl. CPC G09G 3/3225; G09G 2300/043; G09G 2300/0819; G09G 2310/0245; G09G 2310/08; G09G 2320/0247; G09G 2320/041; G09G 2330/021

(57) ABSTRACT

A pixel circuit and a driving method therefor, a display panel and a display device are provided, belonging to the field of display technologies. The pixel circuit includes a plurality of control circuits and one driving circuit. The plurality of control circuits cooperates with each other to control a potential of a first node and a potential of a second node, such that the driving circuit is able to transmit a driving signal to a light-emitting element based on the potential of the first node and the potential of the second node so as to drive the light-emitting element to emit light. Initial signals transmitted by the control circuits to the first node and the second node have a big potential difference.

The present application is a national stage of PCT application No. PCT/CN2023/133275, filed on Nov. 22, 2023, the entire contents of which are incorporated herein by reference.

### TECHNICAL FIELD

The present disclosure relates to the field of display technologies, and in particular, relates to a pixel circuit and a driving method therefor, a display panel and a display device.

### BACKGROUND

Organic light-emitting diode (OLED) display panels are widely used in various types of display products because of their advantages of self-illumination, high contrast, and wide color gamut, wide operating temperature range, and the like.

Currently, an OLED display panel generally includes a plurality of pixels, and the pixel includes a pixel circuit and a light-emitting element (i.e., OLED). The pixel circuit is coupled to the light-emitting element, and the pixel circuit at least includes a driving transistor. The driving transistor is capable of transmitting a drive current to the light-emitting element to drive the light-emitting element to emit light.

However, due to the influence of the characteristic drift of the driving transistor, the pixel circuit cannot reliably drive the light-emitting element to emit light in the related art, which easily results in a temperature drift phenomenon of the display panel, i.e., brightness abnormality with the increase in temperature.

### SUMMARY

Embodiments of the present disclosure provide a pixel circuit and a driving method therefor, a display panel and a display device. The technical solutions are as follows.

In an aspect, a pixel circuit is provided. The pixel circuit is configured to drive a light-emitting element to emit light in a plurality of frame periods which has a target refresh frequency, each of the frame periods comprising a refresh frame and at least one hold frame; the pixel circuit comprising:
a first control circuit, respectively coupled to a first gate control terminal, a second gate control terminal, a data terminal, a first node, a second node, and a third node, wherein the first control circuit is configured to control switching on and off of a connection between the first node and the third node in response to a first gate control signal provided by the first gate control terminal, and configured to control switching on and off of a connection between the data terminal and the second node in response to a second gate control signal provided by the second gate control terminal;
a second control circuit, respectively coupled to a first reset terminal, a second reset terminal, a first initial terminal, a second initial terminal, a third initial terminal, the second node, the third node, and a fourth node, wherein second control circuit is configured to control switching on and off of a connection between the first initial terminal and the third node in response to a first reset signal provided by the first reset terminal, and control switching on and off of a connection between the second initial terminal and the fourth node and control switching on and off of a connection between the third initial terminal and the second node in response to a second reset signal provided by the second reset terminal;
a third control circuit, respectively coupled to a light-emitting control terminal, a driving power supply terminal, the second node, the third node, and the fourth node, wherein the third control circuit is configured to control switching on and off of a connection between the driving power supply terminal and the second node and control switching on and off of a connection between the third node and the fourth node in response to a light-emitting control signal provided by the light-emitting control terminal, the fourth node being coupled to the light-emitting element; and
a driving circuit, respectively coupled to the first node, the second node, and the third node, wherein the driving circuit is configured to transmit a driving signal to the third node based on a potential of the first node and a potential of the second node;
wherein the connection between the first initial terminal and the first node and the connection between the third initial terminal and the third node are sequentially controlled to be switched on in the refresh frame, so that a first initial signal and a third initial signal are sequentially transmitted to the first node and the second node through the first initial terminal and the third initial terminal, respectively, wherein a potential difference between the first initial signal and the third initial signal that are transmitted is greater than or equal to a potential difference threshold.

Optionally, the potential difference threshold is −9V.

Optionally, the first control circuit comprises: a first transistor and a second transistor; the second control circuit comprises: a third transistor, a fourth transistor, and a fifth transistor; the third control circuit comprises: a sixth transistor and a seventh transistor; and the driving circuit comprises: an eighth transistor; wherein a gate of the first transistor is coupled to the first gate control terminal, a first electrode of the first transistor is coupled to the third node, and a second electrode of the first transistor is coupled to the first node;
a gate of the second transistor is coupled to the second gate control terminal, a first electrode of the second transistor is coupled to the data terminal, and a second electrode of the second transistor is coupled to the second node;
a gate of the third transistor is coupled to the first reset terminal, a first electrode of the third transistor is coupled to the first initial terminal, and a second electrode of the third transistor is coupled to the third node;
a gate of the fourth transistor is coupled to the second reset terminal, a first electrode of the fourth transistor coupled to the second initial terminal, and a second electrode of the fourth transistor is coupled to the fourth node;
a gate of the fifth transistor is coupled to the second reset terminal, a first electrode of the fifth transistor is coupled to the third initial terminal, and a second electrode of the fifth transistor is coupled to the second node;
a gate of the sixth transistor is coupled to the light-emitting control terminal, a first electrode of the sixth transistor is coupled to the driving power supply terminal, and a second electrode of the sixth transistor is coupled to the second node;
a gate of the seventh transistor is coupled to the light-emitting control terminal, a first electrode of the seventh transistor is coupled to the third node, and a second electrode of the seventh transistor is coupled to the fourth node;
a gate of the eighth transistor is coupled to the first node, a first electrode of the eighth transistor is coupled to the second node, and a second electrode of the eighth transistor is coupled to the third node;
the pixel circuit further comprising: a storage capacitor connected in series between the driving power supply terminal and the first node.

Optionally, the first transistor is an N-type transistor; and the second transistor to the eighth transistor are P-type transistors; wherein
a material of the N-type transistor comprises an oxide material; and a material of the P-type transistors comprises a low temperature poly-silicon material.

In another aspect, a driving method for a pixel circuit, applicable to driving the pixel circuit as described in the above aspect. The method comprising: sequentially performing a refresh frame and at least one hold frame in each of a plurality of frame periods which has a target refresh frequency; wherein
in the refresh frame, a light-emitting control signal at an effective potential and a light-emitting control signal at an ineffective potential are sequentially provided to a light-emitting control terminal; a first gate control signal at the effective potential and a first gate control signal at the ineffective potential are sequentially provided to a first gate control terminal in at least one period, wherein the first gate control signal at the effective potential is within duration when the light-emitting control signal is at the ineffective potential; and a first reset signal at the effective potential and a second gate control signal at the effective potential are sequentially provided to a first reset terminal and a second gate control terminal and a second reset signal at the ineffective potential is provided to a second reset terminal in duration when the first gate control signal is at the effective potential; and a first reset signal at the ineffective potential and a second gate control signal at the ineffective potential are respectively provided to the first reset terminal and the second gate control terminal and a second reset signal at the effective potential is provided to the second reset terminal in duration when the first gate control signal is at the ineffective potential;
in the hold frame, the light-emitting control signal at the effective potential and the light-emitting control signal at the ineffective potential are sequentially provided to the light-emitting control terminal;
wherein, for any one of the light-emitting control signals, the first gate control signal, the second gate control signal, the first reset signal, and the second reset signal, the signal at the effective potential is used for controlling a connection between coupled portions to be switched on, and the signal at the ineffective potential is used for controlling the connection between coupled portions to be switched off.

Optionally, sequentially providing the first gate control signal at the effective potential and the first gate control signal at the ineffective potential to the first gate control terminal in the at least one period comprises: sequentially providing the first gate control signal at the effective potential and the first gate control signal at the ineffective potential to the first gate control terminal in two periods;
providing the second gate control signal at the effective potential to the second gate control terminal in the duration when the first gate control signal is at the effective potential comprises:
providing the second gate control signal at the effective potential to the second gate control terminal in the duration when the first gate control signal is at the effective potential and in a second period of the two periods;
the method further comprises:
before a first period of the two periods in the refresh frame, providing the light-emitting control signal at the ineffective potential to the light-emitting control terminal, providing the first gate control signal at the ineffective potential to the first gate control terminal, providing the first reset signal at the ineffective potential to the first reset terminal, providing the second gate control signal at the ineffective potential to the second gate control terminal, and providing the second reset signal at the ineffective potential to the second reset terminal.

Optionally, a length of time when the first reset signal is at the effective potential in the second period is greater than or equal to a length of time when the first reset signal is at the effective potential in the second period.

Optionally, a length of time when the first gate control signal is at the ineffective potential and the second reset signal is at the effective potential in the first period is smaller than or equal to a length of time when the first gate control signal is at the ineffective potential and the second reset signal is at the effective potential in the second period.

Optionally, sequentially providing the first gate control signal at the effective potential and the first gate control signal at the ineffective potential to the first gate control terminal in the at least one period comprises: sequentially providing the first gate control signal at the effective potential and the first gate control signal at the ineffective potential to the first gate control terminal in one period;
the method further comprises:
before the one period in the refresh frame, providing the light-emitting control signal at the ineffective potential to the light-emitting control terminal, providing the first gate control signal at the ineffective potential to the first gate control terminal, providing the first reset signal at the ineffective potential to the first reset terminal, providing the second gate control signal at the ineffective potential to the second gate control terminal, and providing the second reset signal at the effective potential to the second reset terminal;
wherein a length of time when the second reset signal is at the effective potential before the one period is greater than a length of time when the second reset signal is at the effective potential in the one period.

Optionally, the length of time when the second reset signal is at the effective potential before the one period is equal to a length of time when the first gate control signal is at the effective potential in the one period.

Optionally, the method further includes:
in the hold frame, providing the first gate control signal at the ineffective potential to the first gate control terminal, providing the first reset signal at the ineffective potential to the first reset terminal, providing the second gate control signal at the ineffective potential to the second gate control terminal, and sequentially providing the second reset signal at the effective potential and the second reset signal at the ineffective potential to the second reset terminal in at least one period, wherein the second reset signal at the effective potential is within the duration when the light-emitting control signal is at the ineffective potential.

Optionally, the target refresh frequency comprises: 120 Hz; and the method comprises: sequentially performing the refresh frame and two hold frames in each of the frame periods.

In yet another aspect, a display panel is provided. The display panel includes: a substrate and a plurality of pixels disposed on the substrate; wherein
each of the plurality of pixels comprises: a light-emitting element, and the pixel circuit as described in the above aspect, wherein the pixel circuit is coupled to the light-emitting element, and is configured to drive the light-emitting element to emit light.

Optionally, the display panel further includes: a plurality of groups of gate driver on array (GOA) circuits in one-to-one correspondence with a first gate control terminal, a second gate control terminal, a first reset terminal, a second reset terminal, and a light-emitting control terminal that are coupled to the pixel circuit; wherein
each group of GOA circuits is coupled to a switch-on signal terminal, a clock signal terminal, and a corresponding signal terminal, and is configured to transmit a signal to the corresponding signal terminal based on a switch-on signal provided by the switch-on signal terminal and a clock signal provided by the clock signal terminal according to the driving method as described above.

In still another aspect, a display device is provided. The display device includes: a power supply assembly, and the display panel as described in the yet another aspect; wherein
the power supply assembly is coupled to the display panel, and is configured to supply power to the display panel.

### BRIEF DESCRIPTION OF DRAWINGS

For clearer descriptions of the technical solutions in the embodiments of the present disclosure, the following briefly introduces the accompanying drawings required for describing the embodiments. The accompanying drawings in the following descriptions show merely some embodiments of the present disclosure, and persons of ordinary skill in the art may still derive other drawings from these accompanying drawings without creative effort.

FIG. 1 is a schematic structural diagram of a pixel circuit according to an embodiment of the present disclosure;

FIG. 2 is a circuit structural diagram of a pixel circuit according to an embodiment of the present disclosure;

FIG. 3 is a flowchart of a driving method for a pixel circuit according to an embodiment of the present disclosure;

FIG. 4 is a timing diagram of signal terminals coupled to a pixel circuit according to an embodiment of the present disclosure;

FIG. 5 is a timing diagram of signal terminals coupled to another pixel circuit according to an embodiment of the present disclosure;

FIG. 6 is a timing diagram of signal terminals coupled to yet another pixel circuit according to an embodiment of the present disclosure;

FIG. 7 is a timing diagram of signal terminals coupled to still another pixel circuit according to an embodiment of the present disclosure;

FIG. 8 is a schematic diagram of frequency conversion according to an embodiment of the present disclosure;

FIG. 9 is a schematic diagram of a decrease amplitude of an x-color coordinate according to an embodiment of the present disclosure;

FIG. 10 is a schematic diagram of a decrease amplitude of a y color coordinate according to an embodiment of the present disclosure;

FIG. 11 is a schematic diagram of a decrease amplitude of brightness according to an embodiment of the present disclosure;

FIG. 12 is a schematic structural diagram of a display panel according to an embodiment of the present disclosure;

FIG. 13 is a signal timing diagram of a GOA circuit corresponding to a first gate control terminal according to an embodiment of the present disclosure;

FIG. 14 is a signal timing diagram of a GOA circuit corresponding to a second gate control terminal according to an embodiment of the present disclosure;

FIG. 15 is a signal timing diagram of a GOA circuit corresponding to a first reset terminal according to an embodiment of the present disclosure;

FIG. 16 is a signal timing diagram of a GOA circuit corresponding to a second reset terminal according to an embodiment of the present disclosure;

FIG. 17 is a signal timing diagram of a GOA circuit corresponding to a light-emitting control terminal according to an embodiment of the present disclosure; and

FIG. 18 is a schematic structural diagram of a display device according to an embodiment of the present disclosure.

### DETAILED DESCRIPTION

To make the objective, technical solutions, and advantages of the present disclosure clearer, the embodiments of the present disclosure are further described in detail below with reference to the accompanying drawings.

It should be noted that the transistors used in all the embodiments of the present disclosure are thin film transistors, field-effect transistors or other devices having the same characteristics. The transistors used in the embodiments of the present disclosure are mainly switching transistors according to their functions in the circuit. Since a source and a drain of the switching transistor used herein are symmetrical, the source and the drain are interchangeable. The source is referred to as a first electrode and the drain is referred to as a second electrode, or the drain is referred to as a first electrode and the source is referred to as a second electrode. According to the form in the drawings, an intermediate terminal of the transistor is a gate, a signal input terminal is the source, and a signal output terminal is the drain. In addition, the switching transistors used in the embodiments of the present disclosure include any one or a combination of a P-type transistor and an N-type transistor. The P-type transistor is turned on when the gate is at a low level and is turned off when the gate is at a high level, and the N-type transistor is turned on when the gate is at a high level and turned off when the gate is at a low level. In addition, a plurality of signals in the embodiments of the present disclosure each correspond to a first potential and a second potential. The first potential and the second potential only represent that the signal has potentials with two different state quantities, but do not represent that the first potential or the second potential has a specific value.

Temperature drift is explained in combination with the background technology and Table 1 below. Temperature drift refers to the difference in brightness/chroma of a display product (e.g., a mobile phone) when the screen temperature of the product rises from normal temperature (e.g., 25° C.) (for example, rises to 50° C.). The larger the difference, the worse the display effect, and the more unfavorable to the display product. Examples of scenarios where the temperature rises are charging or gaming.

TABLE 1

| | | | | | | | | | ΔWx | ΔWy | ΔLW |
|---|---|---|---|---|---|---|---|---|---|---|---|
| Temp | Band | Pattern | x | y | Lv | ΔWx | ΔWy | ΔLW | % | % | % |
| Normal | 2 nit | W32 | 0.332 | 0.340 | 0.021 | | | | | | |
| temperature | | | | | | | | | | | |
| 50° C. | 2 nit | W32 | 0.183 | 0.081 | 0.006 | 0.149 | 0.259 | 0.015 | 44.80% | 76.04% | 70.04% |
| Normal | 2 nit | W32 | 0.314 | 0.330 | 0.017 | | | | | | |
| temperature | | | | | | | | | | | |
| 50° C. | 2 nit | W32 | 0.160 | 0.064 | 0.006 | 0.155 | 0.266 | 0.010 | 49.23% | 80.53% | 62.43% |

In Table 1, Temp refers to temperature; Band refers to a display brightness level, which is shown as 2 nits in the table; Pattern refers to a display screen, which is shown as a white (W) screen in 32 grayscale in the table; x and y refer to an x-color coordinate and a y-color coordinate, respectively; Lv refers to brightness, which is expressed in units of candela per square meter (cd/m²); ΔWx and Wx % refer to an amount and rate of change of the x-color coordinate from normal temperature to 50° C., respectively; ΔWy and ΔWy % refer to an amount and rate of change of the y-color coordinate from normal temperature to 50° C., respectively; and ΔLW and ΔLW % refer to an amount and rate of change of brightness from normal temperature to 50° C., respectively. Combined with Table 1, it can be seen that the brightness difference of the temperature drift is about 50% to 70% currently, and the screen brightness will mostly decrease rapidly after the temperature rises, for example, the display screen turns from white to blue rapidly, resulting in a poor display effect.

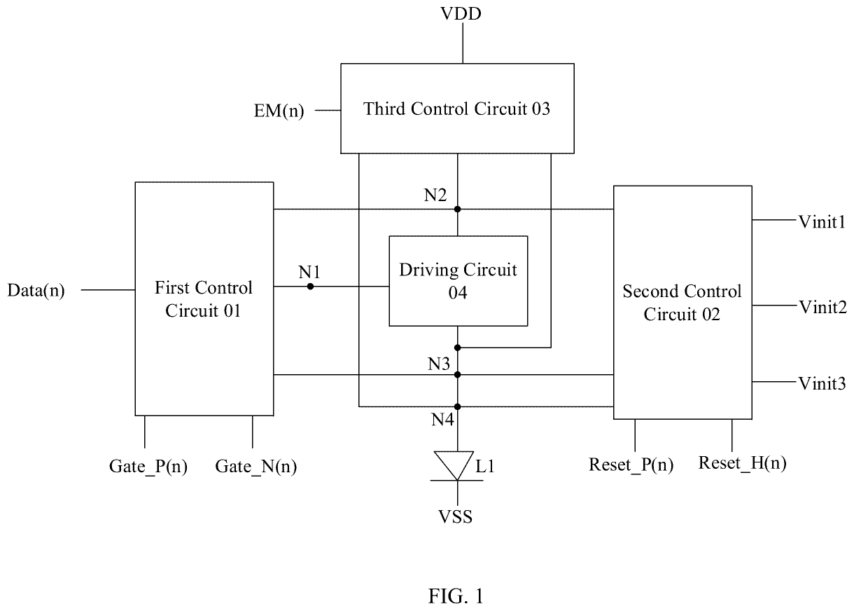

Based on the above, the embodiments of the present disclosure provide a pixel circuit and a driving method therefor, which can solve the temperature drift problem and ensure a better display effect. FIG. 1 is a schematic structural diagram of a pixel circuit according to an embodiment of the present disclosure. The pixel circuit is configured to drive a light-emitting element to emit light in a plurality of frame periods which has a target refresh frequency, and each of the frame periods includes a refresh frame and at least one hold frame. As shown in FIG. 1, the pixel circuit comprises: a first control circuit 01, a second control circuit 02, a third control circuit 03, and a driving circuit 04.

The first control circuit 01 is coupled to a first gate control terminal Gate_N(n), a second gate control terminal Gate_P(n), a data terminal Data(n), a first node N1, a second node N2, and a third node N3. The first control circuit 01 is configured to control the switching on and off of a connection between the first node N1 and third node N3 in response to a first gate control signal provided by the first gate control terminal Gate_N(n), and control the switching on and off of a connection between the data terminal Data(n) and the second node N2 in response to a second gate control signal provided by the second gate control terminal Gate_P(n).

Exemplarily, the first control circuit 01 controls the connection between the first node N1 and the third node N3 to be switched on when the first gate control signal provided by the first gate control terminal Gate_N(n) is at an effective potential, such that a signal transmitted to the third node N3 is further transmitted to the first node N1. The first control circuit 01 controls the switching on and off of a connection between the first node N1 and the third node N3 when the gate control signal is at an ineffective potential.

Similarly, the first control circuit 01 controls the connection between the data terminal Data(n) and the second node N2 to be switched on when the second gate control signal provided by the second gate control terminal Gate_P(n) is at an effective potential, such that a data signal provided by the data terminal Data(n) is transmitted to the second node N2. The first control circuit 01 controls the connection between the data terminal Data(n) and the second node N2 to be switched off when the second gate control signal provided by the second gate control terminal Gate_P(n) is at an ineffective potential.

Optionally, for the P-type transistors in the circuit, the effective potential is a low potential relative to the ineffective potential, and for the N-type transistors in the circuit, the effective potential is a high potential relative to the ineffective potential.

With continued reference to FIG. 1, it can be seen that the second control circuit 02 is coupled to a first reset terminal Reset_P(n), a second reset terminal Reset_H(n), a first initial terminal Vinit1, a second initial terminal Vinit2, a third initial terminal Vinit3, the second node N2, the third node N3, and a fourth node N4. The second control circuit 02 is configured to control the switching on and off of a connection between the first initial terminal Vinit1 and the third node N3 in response to a first reset signal provided by the first reset terminal Reset_P(n), and configured to, in response to a second reset signal provided by the second reset terminal Reset_H(n), control the switching on and off of a connection between the second initial terminal Vinit2 and the fourth node N4 and control the switching on and off of a connection between the third initial terminal Vinit3 and the second node N2.

Exemplarily, the second control circuit 02 controls the connection between the first initial terminal Vinit1 and the third node N3 to be switched on when the first reset signal provided by the first reset terminal Reset_P(n) is at the effective potential, such that a first initial signal provided by the first initial terminal Vinit1 is transmitted to the third node N3. On this basis, when the first control circuit 01 controls the connection between the first node N1 and the third node N3 to be switched on at the same time, the first initial signal transmitted to the third node N3 is further transmitted to the first node N1, that is, the first initial signal is written into the first node N1. The second control circuit 02 controls the connection between the first initial terminal Vinit1 and the third node N3 to be switched off when the first reset signal provided by the first reset terminal Reset_P(n) is at the ineffective potential.

Similarly, when the second reset signal provided by the second reset terminal Reset_H(n) is at the effective potential, the second control circuit 02 controls the connection between the second initial terminal Vinit2 and the fourth node N4 to be switched on and controls the connection between the third initial terminal Vinit3 and the second node N2 to be switched on, such that a second initial signal provided by the second initial terminal Vinit2 is transmitted to the fourth node N4 and a third initial signal provided by the third initial terminal Vinit3 is transmitted to the second node N2. When the second reset signal provided by the second reset terminal Reset_H(n) is at the ineffective potential, the second control circuit 02 controls the connection between the second initial terminal Vinit2 and the fourth node N4 to be switched off and controls the connection between the third initial terminal Vinit3 and the second node N2 to be switched off.

Optionally, the fourth node N4 is coupled to a light-emitting element L1. Referring to FIG. 1, the light-emitting element L1 may be an OLED having a first electrode and a second electrode, and one of the first electrode and the second electrode is an anode and the other electrode is a cathode. The fourth node N4 is coupled to the anode of the light-emitting element L1 as shown in FIG. 1, and the cathode of the light-emitting element L1 is coupled to a pull-down power supply terminal VSS.

With continued reference to FIG. 1, it can be seen that the third control circuit 03 is coupled to a light-emitting control terminal EM(n), a driving power supply terminal VDD, the second node N2, the third node N3, and the fourth node N4. The third control circuit 03 is configured to, in response to a light-emitting control signal provided by the light-emitting control terminal EM(n), control the switching on and off of a connection between the driving power supply terminal VDD and the second node N2 and control the switching on and off of a connection between the third node N3 and the fourth node N4.

Exemplarily, when the light-emitting control signal provided by the light-emitting control terminal EM(n) is at the effective potential, the third control circuit 03 controls the connection between the driving power supply terminal VDD and the second node N2 to be switched on and controls the connection between the third node N3 and the fourth node N4 to be switched on, such that a driving power supply signal provided by the driving power supply terminal VDD is transmitted to the second node N2 and the signal transmitted to the third node N3 is further transmitted to the fourth node N4. That is, a path is formed between the driving power supply terminal VDD and the pull-down power supply terminal VSS, and the light-emitting element L1 can emit light reliably under the effect of the voltage difference between the signals received at the anode and cathode. When the light-emitting control signal provided by the light-emitting control terminal EM(n) is at the ineffective potential, the third control circuit 03 controls the switching on and off of a connection between the driving power supply terminal VDD and the second node N2 and controls the connection between the third node N3 and the fourth node N4 to be switched off.

With continued reference to FIG. 1, it can be seen that the driving circuit 04 is coupled to the first node N1, the second node N2, and the third node N3. The driving circuit 04 is configured to transmit a drive signal (e.g., a drive current) to the third node N3 based on the potential of the first node N1 and the potential of the second node N2. On this basis, when the third control circuit 03 controls the connection between the third node N3 and the fourth node N4 to be switched on, the drive signal transmitted to the third node N3 is further transmitted to the fourth node N4, i.e., to the anode of the light-emitting element L1. At this time, the light-emitting element L1 can emit light under the voltage difference between the drive signal and the pull-down power supply signal provided by the pull-down power supply terminal VSS.

In the refresh frame, the connection between the first initial terminal Vinit1 and the first node N1 and the connection between the third initial terminal Vinit3 and the third node N3 are sequentially controlled to be switched on, such that the first initial terminal Vinit1 transmits the first initial signal and the third initial terminal Vinit3 transmits the third initial signal sequentially to the first node N1 and the second node N2. In addition, the potential difference between the transmitted first initial signal and third initial signal is greater than or equal to a potential difference threshold, that is, the difference between the two is larger. In this way, the pressure difference between the first node N1 and the second node N2 is larger, and thus the bias voltage Stress of the driving transistor in the driving circuit 04 is larger. The larger the bias voltage Stress is, the less the operation of the driving circuit 04 is affected by the characteristic drift. Therefore, the driving circuit 04 can reliably transmit the drive signal to the light-emitting element L1, thereby avoiding a large difference in the brightness of the light-emitting element L1 before and after the rise of temperature, i.e., solving the temperature drift problem.

It should be noted that in the embodiments of the present disclosure, the pixel circuit and the light-emitting element that are mutually coupled may be referred to as a pixel. The display panel includes a plurality of pixels arranged in an array, and the above xx (n) may refer to the xx signal terminal coupled to the pixel circuits in the n-th row of pixels. For example, the first gate control terminal Gate_N(n) refers to the first gate control terminal Gate_N coupled to the pixel circuits in the n-th row of pixels.

In summary, the embodiments of the present disclosure provide a pixel circuit. The pixel circuit includes a plurality of control circuits and one driving circuit. The plurality of control circuits cooperates with each other to control the potential of the first node and the potential of the second node, such that the driving circuit can transmit a driving signal to the light-emitting element based on the potential of the first node and the potential of the second node so as to drive the light-emitting element to emit light. The initial signals transmitted by the control circuits to the first node and the second node have a big potential difference. In this way, the bias voltage of the driving transistor in the driving circuit is as big as possible, which ensures that the driving circuit can still reliably drive the light-emitting element to emit light even after the temperature rises, thereby solving the temperature drift problem of the display panel and ensuring a better display effect of the display panel.

Optionally, in some embodiments, the potential difference threshold is −9 volts (V). That is, the potential difference between the first initial signal and the third initial signal is greater than or equal to −9V.

Exemplarily, the potential Vinit10 of the first initial power supply signal is greater than or equal to −6V and less than or equal to −1V; and the potential Vinit20 of the second initial power supply signal is greater than or equal to 3V and less than or equal to 7V.

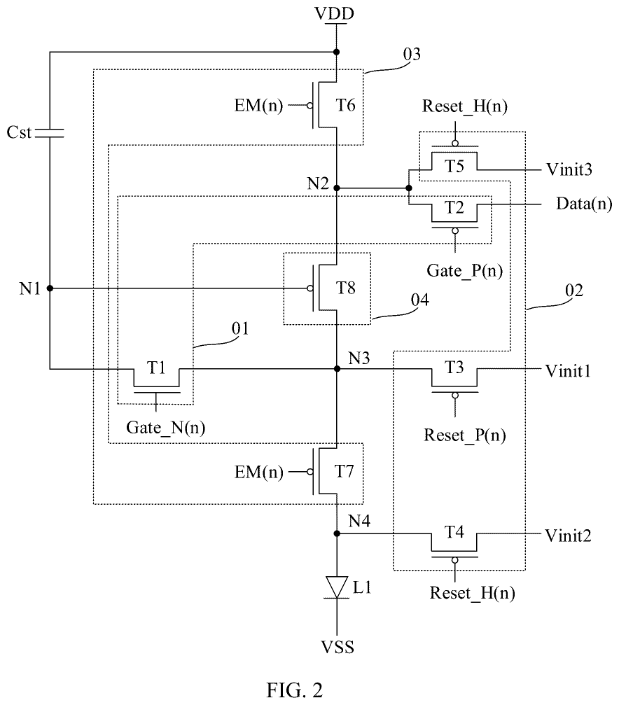

Optionally, on the basis of the structure shown in FIG. 1, FIG. 2 shows a circuit structural diagram of a pixel circuit. As shown in FIG. 2, the first control circuit 01 includes a first transistor T1 and a second transistor T2; the second control circuit 02 includes a third transistor T3, a fourth transistor T4, and a fifth transistor T5; the third control circuit 03 includes a sixth transistor T6 and a seventh transistor T7; and the driving circuit 04 includes an eighth transistor T8.

A gate of the first transistor T1 is coupled to the first gate control terminal Gate_N(n), a first electrode of the first transistor T1 is coupled to the third node N3, and a second electrode of the first transistor T1 is coupled to the first node N1.

A gate of the second transistor T2 is coupled to the second gate control terminal Gate_P(n), a first electrode of the second transistor T2 is coupled to the data terminal Data(n), and a second electrode of the second transistor T2 is coupled to the second node N2.

A gate of the third transistor T3 is coupled to the first reset terminal Reset_P(n), a first electrode of the third transistor T3 is coupled to the first initial terminal Vinit1, and a second electrode of the third transistor T3 is coupled to the third node N3.

A gate of the fourth transistor T4 is coupled to the second reset terminal Reset_H(n), a first electrode of the fourth transistor T4 is coupled to the second initial terminal Vinit2, and a second electrode of the fourth transistor T4 is coupled to the fourth node N4.

A gate of the fifth transistor T5 is coupled to the second reset terminal Reset_H(n), a first electrode of the fifth transistor T5 is coupled to the third initial terminal Vinit3, and a second electrode of the fifth transistor T5 is coupled to the second node N2.

A gate of the sixth transistor T6 is coupled to the light-emitting control terminal EM(n), a first electrode of the sixth transistor T6 is coupled to the driving power supply terminal VDD, and a second electrode of the sixth transistor T6 is coupled to the second node N2.

A gate of the seventh transistor T7 is coupled to the light-emitting control terminal EM(n), a first electrode of the seventh transistor T7 is coupled to the third node N3, and a second electrode of the seventh transistor T7 is coupled to the fourth node N4.

A gate of the eighth transistor T8 is coupled to the first node N1, a first electrode of the eighth transistor T8 is coupled to the second node N2, and a second electrode of the eighth transistor T8 is coupled to the third node N3.

The pixel circuit further includes a storage capacitor Cst connected in series between the driving power supply terminal VDD and the first node N1.

Optionally, with continued reference to FIG. 2, it can be seen that the first transistor T1 is an N-type transistor, and the second transistor T2 to the eighth transistor T8 are all P-type transistors.

Moreover, the material of the N-type transistor includes an oxide material, and the material of the P-type transistor includes a low temperature poly-silicon (LTPS) material. It should be noted that the material of the transistor herein refers to the material of the active layer included in the transistor. The transistors made of the low temperature poly-silicon material have the advantages of high mobility, fast charging and the like, and the transistors made of the oxide material have the advantages of low leakage current and the like. A display panel integrated with the two types of transistors, i.e., an LTPS+Oxide (LTPO) display panel, can take advantages of the two types of transistors to achieve low-frequency driving and reduce power consumption, thereby improving the display quality.

Optionally, the pixel circuit shown in FIG. 2 is considered as a circuit with an 8TIC (i.e., 8 transistors and 1 capacitor) structure. In some other embodiments, the pixel circuit may also be of other structures, such as 7TIC, which is not limited in the embodiments of the present disclosure.

In conjunction with the pixel circuit shown in FIG. 2, it can also be seen that the potential difference “Vinit10−Vinit20” between the potential Vinit10 of the first initial power supply signal transmitted by the eighth transistor T8 (i.e., the driving transistor) to the first node N1 and the potential Vinit20 of the second initial power supply signal transmitted by the eighth transistor T8 to the second node N2 is the gate-source voltage difference Vgs of the driving transistor, i.e. Vgs=Vinit10−Vinit20≈−9V. This can achieve the purpose of increasing the bias voltage Stress of the driving transistor and solve the problem of the poor display effect caused by temperature drift.

In summary, the embodiments of the present disclosure provide a pixel circuit. The pixel circuit includes a plurality of control circuits and one driving circuit. The plurality of control circuits cooperates with each other to control the potential of the first node and the potential of the second node, such that the driving circuit can transmit a driving signal to the light-emitting element based on the potential of the first node and the potential of the second node so as to drive the light-emitting element to emit light. The initial signals transmitted by the control circuits to the first node and the second node have a big potential difference. In this way, the bias voltage of the driving transistor in the driving circuit is as big as possible, which ensures that the driving circuit can still reliably drive the light-emitting element to emit light even after the temperature rises, thereby solving the temperature drift problem of the display panel and ensuring a better display effect of the display panel.

On the basis of the above structure of the pixel circuit, the embodiments of the present disclosure provide a driving method for a pixel circuit to drive the pixel circuit in the foregoing embodiments, in order to achieve the purpose of increasing the bias voltage Stress of the driving transistor.

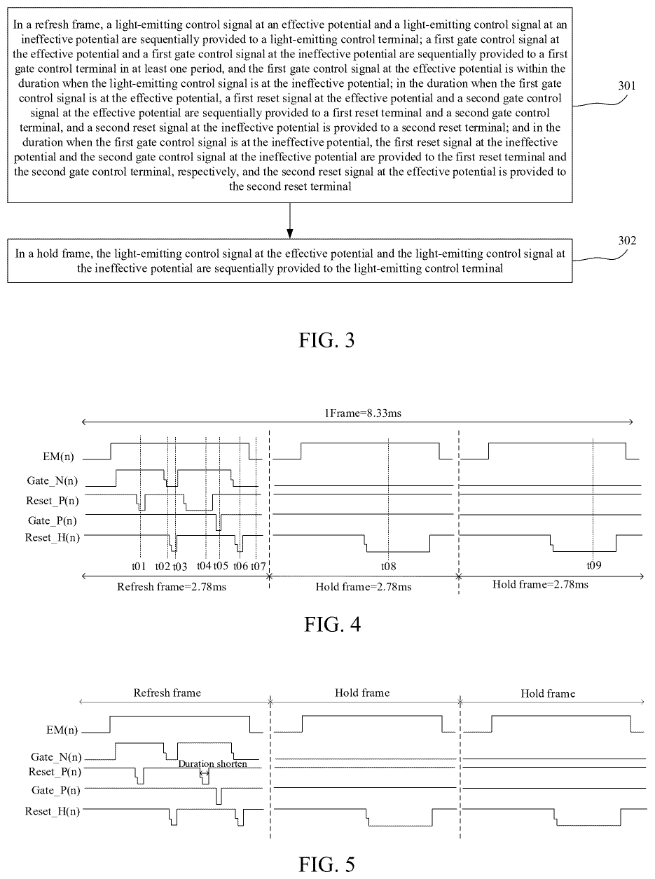

FIG. 3 is a flowchart of a driving method according to an embodiment of the present disclosure. The method includes: sequentially performing a refresh frame and at least one hold frame in each of the frame periods of a plurality of frame periods which has a target refresh frequency.

In step 301, in a refresh frame, a light-emitting control signal at an effective potential and a light-emitting control signal at an ineffective potential are sequentially provided to a light-emitting control terminal; a first gate control signal at the effective potential and a first gate control signal at the ineffective potential are sequentially provided to a first gate control terminal in at least one period, and the first gate control signal at the effective potential is within the duration when the light-emitting control signal is at the ineffective potential; in the duration when the first gate control signal is at the effective potential, a first reset signal at the effective potential and a second gate control signal at the effective potential are sequentially provided to a first reset terminal and a second gate control terminal, and a second reset signal at the ineffective potential is provided to a second reset terminal; and in the duration when the first gate control signal is at the ineffective potential, the first reset signal at the ineffective potential and the second gate control signal at the ineffective potential are provided to the first reset terminal and the second gate control terminal, respectively, and the second reset signal at the effective potential is provided to the second reset terminal.

In step 302, in a hold frame, the light-emitting control signal at the effective potential and the light-emitting control signal at the ineffective potential are sequentially provided to the light-emitting control terminal.

As can be seen from the foregoing embodiments, for any one of the light-emitting control signals, the first gate control signal, the second gate control signal, the first reset signal, and the second reset signal, the signal at the effective potential is used for controlling the connection between coupled portions to be switched on, and the signal at the ineffective potential is used for controlling the connection between coupled portions to be switched off. For example, in connection with FIG. 1, the first gate control signal at the effective potential enables the first control circuit 01 to control the coupled first node N1 and third node N3 to be switched on, and the first gate control signal at the ineffective potential enables the first control circuit 01 to control the coupled first node N1 and third node N3 to be switched off.

Optionally, on the basis of the above driving method, the following embodiments give multiple timing design examples.

In an optional implementation:

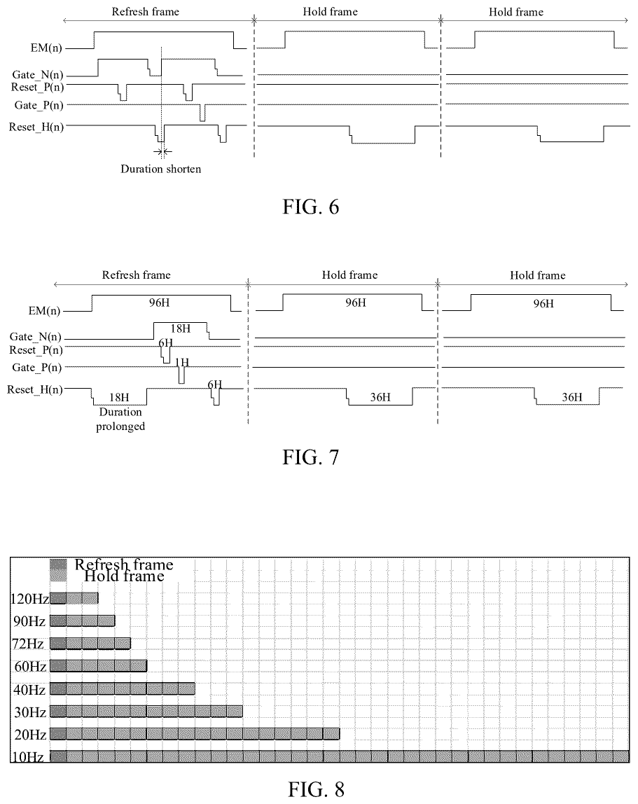

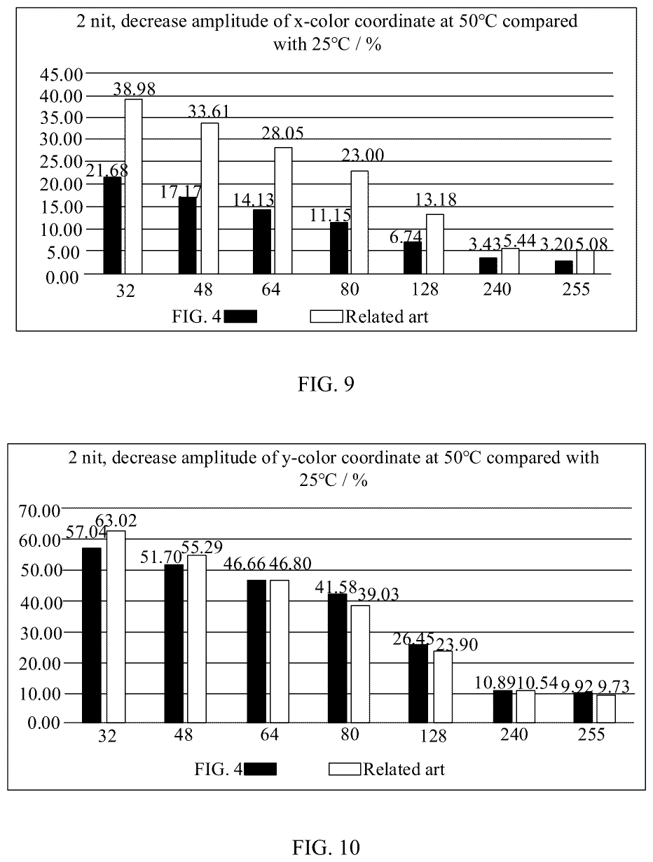

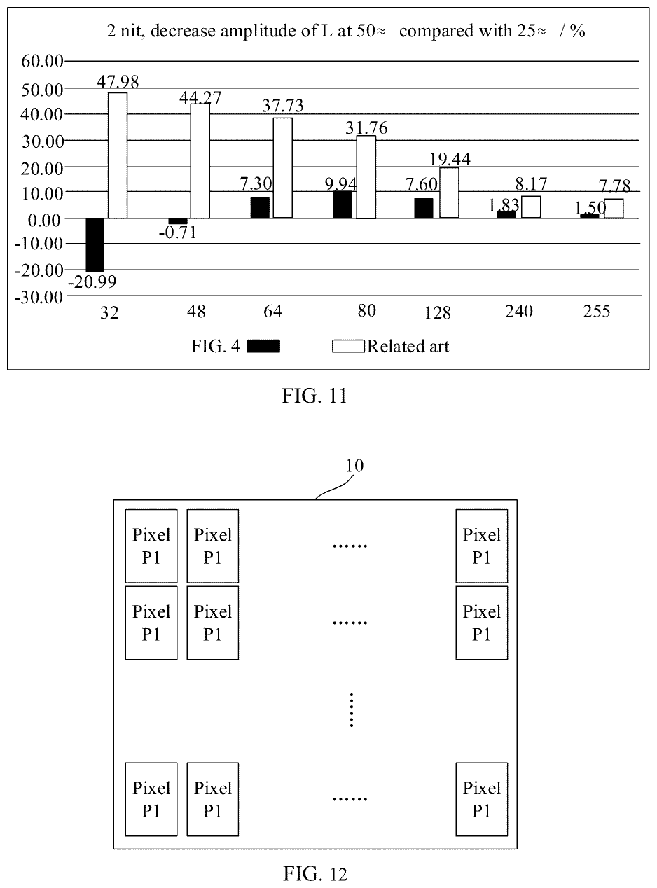

As can be seen in conjunction with the timing diagram illustrated in FIG. 4, providing the first gate control signal at the effective potential and the first gate control signal at the ineffective potential sequentially to the first gate control terminal Gate_N(n) in at least one period the above step 301 includes:
providing the first gate control signal at the effective potential and the first gate control signal at the ineffective potential sequentially to the first gate control terminal Gate_N(n) in two periods. That is, the operation of providing the first gate control signal at the effective potential and the first gate control signal at the ineffective potential sequentially to the first gate control terminal Gate_N(n) is performed twice.

On this basis, with continued reference to FIG. 4, it can be seen that providing the second gate control signal at the effective potential to the second gate control terminal Gate_P(n) in the duration when the first gate control signal is at the effective potential in the above step 301 includes:
providing the second gate control signal at the effective potential to the second gate control terminal Gate_P(n) in the duration when the first gate control signal is at the effective potential in the second period of the two periods.

Additionally, the driving method further includes:
before the first period of the two periods in the refresh frame, providing the light-emitting control signal at the ineffective potential to the light-emitting control terminal EM(n), providing the first gate control signal at the ineffective potential to the first gate control terminal Gate_N(n), providing the first reset signal at the ineffective potential to the first reset terminal Reset_P(n), providing the second gate control signal at the ineffective potential to the second gate control terminal Gate_P(n), and providing the second reset signal at the ineffective potential to the second reset terminal Reset_H(n).

Optionally, as shown in FIG. 4, the duration when the first reset signal is at the effective potential in the second period is greater than the duration when the first reset signal is at the effective potential in the second period.

Alternatively, for the generated timing 1 shown in FIG. 5, the duration when the first reset signal is at the effective potential in the second period is equal to the duration when the first reset signal is at the effective potential in the second period. Certainly, in some other embodiments, the duration when the first reset signal is at the effective potential in the second period may also be shorter than the duration when the first reset signal is at the effective potential in the second period.

The generated timing 1 shown in FIG. 5 may be considered to shorten the duration when the first reset signal is at the effective potential in the second period on the basis of FIG. 4, i.e., the “duration shortening” shown in FIG. 5.

Optionally, as shown in FIG. 4, the length of time when the first gate control signal is at the ineffective potential and the second reset signal is at the effective potential in the first period is equal to the length of time when the first gate control signal is at the ineffective potential and the second reset signal is at the effective potential in the second period.

Alternatively, for the generated timing 2 shown in FIG. 6, the length of time when the first gate control signal is at the ineffective potential and the second reset signal is at the effective potential in the first period is shorter than the length of time when the first gate control signal is at the ineffective potential and the second reset signal is at the effective potential in the second period. Certainly, in some other embodiments, the length of time when the first gate control signal is at the ineffective potential and the second reset signal is at the effective potential in the first period may also be longer than the length of time when the first gate control signal is at the ineffective potential and the second reset signal is at the effective potential in the second period.

The generated timing 2 shown in FIG. 6 may be considered to shorten the length of time when the first gate control signal is at the ineffective potential and the second reset signal is at the effective potential in the first period on the basis of FIG. 4, i.e., the “duration shortening” shown in FIG. 6.

In another optional implementation:

In conjunction with a further timing diagram shown in FIG. 7, it can be seen that providing the first gate control signal at the effective potential and the first gate control signal at the ineffective potential sequentially to the first gate control terminal Gate_N(n) in at least one period the above step 301 includes: providing the first gate control signal at the effective potential and the first gate control signal at the ineffective potential sequentially to the first gate control terminal Gate_N(n) in one period. That is, the operation of providing the first gate control signal at the effective potential and the first gate control signal at the ineffective potential sequentially to the first gate control terminal Gate_N(n) is performed only once.

On this basis, with continued reference to FIG. 7, it can be seen that the driving method further includes:
before one period in the refresh frame, providing the light-emitting control signal at the ineffective potential to the light-emitting control terminal EM(n), providing the first gate control signal at the ineffective potential to the first gate control terminal Gate_N(n), providing the first reset signal at the ineffective potential to the first reset terminal Reset_P(n), providing the second gate control signal at the ineffective potential to the second gate control terminal Gate_P(n), and providing the second reset signal at the effective potential to the second reset terminal Reset_H(n).

Additionally, the duration when the second reset signal is at the effective potential before one period is greater than the duration when the second reset signal is at the effective potential in one period. That is, the duration when the second reset signal is at the effective potential for the first time can be prolonged as much as possible, and reference may be made to the “duration prolonging” identified in FIG. 7.

Optionally, with continued reference to FIG. 7, in some embodiments, the duration when the second reset signal is at the effective potential before one period may be equal to the duration when the first gate control signal is at the effective potential in one period, for example, both are 18H. In addition, the duration of other signals provided are schematically identified in FIG. 7.

Optionally, with reference to FIG. 4 to FIG. 7, it can also be seen that the driving method further includes:
in a hold frame, providing the first gate control signal at the ineffective potential to the first gate control terminal Gate_N(n), providing the first reset signal at the ineffective potential to the first reset terminal Reset_P(n), providing the second gate control signal at the ineffective potential to the second gate control terminal Gate_P(n), and providing the second reset signal at the effective potential and the second reset signal at the ineffective potential sequentially to the second reset terminal Reset_H(n) in at least one period, wherein the second reset signal at the effective potential is within the duration when the light-emitting control signal is at the ineffective potential.

Exemplarily, in all the timings shown in FIG. 4 to FIG. 7, the second reset signal at the effective potential and the second reset signal at the ineffective potential are sequentially provided to the second reset terminal Reset_H(n) in one period of the hold frame.

Optionally, taking the structure shown in FIG. 2 and the timing shown in FIG. 4 as an example, the operating principle of the pixel circuit is described as follows.

At the moment t01, the first gate control signal at the effective potential (i.e., the high potential) is provided to the first gate control terminal Gate_N(n), and the first reset signal at the effective potential (i.e., the low potential) is provided to the first reset terminal Reset_P(n). On this basis, the first transistor T1 and the third transistor T3 are turned on. Further, the first initial signal provided by the first initial terminal Vinit1 is first transmitted to the third node N3 via the turned-on third transistor T3, and then transmitted to the first node N1 via the turned-on first transistor T1, that is, the first initial signal is written into the gate of the driving transistor, i.e., “eighth transistor T8”.

At the moment t02, the first gate control signal at the ineffective potential (i.e., the low potential) is provided to the first gate control terminal Gate_N(n). On this basis, the first transistor T1 is turned off.

At the moment t03, the second reset signal at the effective potential (i.e., the low potential) is provided to the second reset terminal Reset_H(n). On this basis, the fourth transistor T4 and the fifth transistor T5 are turned on. Further, the second initial signal provided by the second initial terminal Vinit2 is transmitted to the fourth node N4, i.e., the anode of the light-emitting element L1, via the turned-on fourth transistor T4, to reset the light-emitting element L1. In addition, the third initial signal provided by the third initial terminal Vinit3 is transmitted to the second node N2 via the turned-on fifth transistor T5. That is, the third initial signal is written into the source of the driving transistor, i.e., “eighth transistor T8”. At this time, the gate-source voltage difference Vgs of the driving transistor satisfies: Vgs=Vinit10−Vinit30. As described in the foregoing embodiments, in the embodiments of the present disclosure, Vgs=Vinit10−Vinit30≈−9 V, and the bias voltage Stress of the driving transistor is larger.

At the moment t04, the first gate control signal at the effective potential is provided to the first gate control terminal Gate_N(n) and the first reset signal at the effective potential is provided to the first reset terminal Reset_P(n) again to turn on the first transistor T1 and the third transistor T3 again, such that the first initial signal is written into the gate of the driving transistor, i.e., “eighth transistor T8” again, to reset the storage capacitor Cst.

It should be noted that in the timing shown in FIG. 4, the duration when the first reset signal provided at the moment t04 is at the effective potential is greater than the duration when the first reset signal provided at the moment t01 is at the effective potential. For example, the duration is 6H the moment t01, and the duration is prolonged to 14H at the moment t04. In the generated timing 1 shown in FIG. 5, the duration when the first reset signal provided at the moment t04 is at the effective potential is shortened, which helps mitigate the brightness difference caused by the temperature change.

At the moment t05, it is continued to provide the first gate control signal at the effective potential to the first gate control terminal Gate_N(n), and provide the second gate control signal at the effective potential (i.e., the low potential) to the second gate control terminal Gate_P(n). On this basis, the first transistor T1 remains turned on and the second transistor T2 is turned on. Further, the data signal provided by the data terminal Data(n) is transmitted to the second node N2 via the turned-on second transistor T2, and the eighth transistor T8 is turned on because the first initial signal is written into the first node N1 at the moment t04. Further, at the moment t05, the data signal transmitted to the second node N2 is transmitted to the third node N3 via the turned-on eighth transistor T8, and is then transmitted to the first node N1 via the turned-on first transistor T1, that is, the data signal is written into the gate of the driving transistor, i.e., the “eighth transistor T8”, which facilitates the compensation for the threshold voltage Vth of the driving transistor later.

At the moment t06, the first gate control signal at the ineffective potential is provided to the first gate control terminal Gate_N(n), and the second reset signal at the effective potential is provided to the second reset terminal Reset_H(n) again. On this basis, the first transistor T1 is turn off, and the fourth transistor T4 and the fifth transistor T5 are turned on again. Further, the second initial signal provided by the second initial terminal Vinit2 is transmitted to the fourth node N4, i.e., the anode of the light-emitting element L1, via the turned-on fourth transistor T4, to reset the light-emitting element L1. Furthermore, the third initial signal provided by the third initial terminal Vinit3 is transmitted to the second node N2 via the turned-on fifth transistor T5. Additionally, because the eighth transistor T8 is turned on at the moment t05, the eighth transistor T8 remains turned on at the moment t06 under the holding effect of the storage capacitor Cst. Further, the third initial signal transmitted to the second node N2 is transmitted to the third node N3 via the turned-on eighth transistor T8 again, that is, at the moment t06, the third initial signal is written into the second node N2 and the third node N3, and the second initial signal is written into the light-emitting element L1. In this way, the flicker can be ameliorated, which may be characterized by a variable refresh rate (VRR), i.e., the VRR can be improved.

At the moment t07, the light-emitting control signal at the effective potential (i.e., the low potential) is provided to the light-emitting control terminal EM(n). On this basis, the sixth transistor T6 and the seventh transistor T7 are turned on. Further, a path is formed between the driving power supply terminal VDD and the pull-down power supply terminal VSS, to drive the light-emitting element L1 to emit light reliably.

At the moment t08, the light-emitting control signal at the ineffective potential (i.e., the high potential) is provided to the light-emitting control terminal EM(n), and the second reset signal at the effective potential is provided to the second reset terminal Reset_H(n). On this basis, the sixth transistor T6 and the seventh transistor T7 are turned off, and the fourth transistor T4 and the fifth transistor T5 are turned on. Further, the third initial signal is written into the second node N2 and the third node N3, and the second initial signal is written into the light-emitting element L1. In this way, the VRR/Flicker problem can be ameliorated. The moment t09 is consistent with the moment t08.

It should be noted that by comparing the generated timings 2 shown in FIG. 4 and FIG. 6, it can be seen that the time duration of the t03 moment is relatively reduced, which is beneficial to the optimization of the flicker. Furthermore, by comparing the generated timings 3 shown in FIG. 4 and FIG. 7, it can be seen that the effective duration of the second reset signal provided for the first time is prolonged, which is also beneficial to the optimization of the flicker.

In FIG. 4, the moments t01 to t03 may be considered as the first period of providing the first gate control signal at the effective potential and the first gate control signal at the ineffective potential sequentially to the first gate control terminal Gate_N(n); and the moments t04 to t07 may be considered as the second period of providing the first gate control signal at the effective potential and the first gate control signal at the ineffective potential sequentially to the first gate control terminal Gate_N(n). Moments t01 to t07 are in the refresh frame, and moments t08 and t09 are in two hold frames, respectively. That is, the driving method according to the embodiments of the present disclosure includes a refresh frame and two hold frames executed sequentially in each of the frame periods.

It can also be seen that in the hold frames, the signals at the effective potential are provided to the light-emitting control terminal EM(n) and the second reset terminal Reset_H(n) only, i.e., only the fourth transistor T4 to the seventh transistor T7 are selected to be turned on. The target refresh frequency is 120 Hz. In addition, in consideration of a high-precision frequency conversion, the second reset terminal Reset_H(n) may adopt a 3-pulse design. That is, in the timings shown in FIG. 4 to FIG. 7, one frame is divided into one refresh frame and two hold frames as described in the foregoing embodiments. Assuming that the duration of one frame is 8.33 milliseconds (ms), the duration of each of the one refresh frame and the two hold frames is 2.78 ms. On this basis, the refresh rate of the second reset terminal Reset_H(n) adopting the 3-pulse design is 360 Hz. In this way, a higher-precision frequency conversion can be achieved by increasing the number of hold frames in each of the frame periods.

For example, referring to FIG. 8, taking 360 Hz as a base, the timings with the 3-pulse design in FIG. 4 to FIG. 7 includes one refresh frame and two hold frames, thereby achieving a 120 Hz refresh frequency. Similarly, a 90 Hz refresh frequency can be achieved when the timing includes one refresh frame and three hold frames, i.e., adding one hold frame; a 72 Hz refresh frequency can be achieved when the timing includes one refresh frame and four hold frames, i.e., adding two hold frames; a 60 Hz refresh frequency can be achieved when the timing includes one refresh frame and five hold frames, i.e., adding three hold frames. This is the same for the others, and details are not repeated herein. It can be seen that the driving method according to the embodiments of the present disclosure can achieve the purpose of frequency conversion.

Optionally, in some other embodiments, the second reset terminal Reset_H(n) may also adopt a 2-pulse or 4-pulse design. Alternatively, the second reset signal at the effective potential is not provided to the second reset terminal Reset_H(n) in the hold frames. Alternatively, the first reset signal at the effective potential is provided to the first reset terminal Reset_P(n) in the hold frames to turn on the third transistor T3.

On the basis of the different timing designs shown in FIG. 4 through FIG. 7 above, Table 2 below shows the data on the corresponding temperature drift improvements.

TABLE 2

| | Improvement on temperature | 90 nitL16 |
|---|---|---|
| Item | drift-brightness difference | Flicker |
| Timing in FIG. 4 | −23%~−27% | −36.3 db |
| | Ave. ΔL ≈ 25% | |
| Timing in FIG. 5 | ΔL < 10% | −29.0 db |
| Timing in FIG. 6 | −7%~−23% | −27.6 db |
| | Ave. ΔL ≈ 13% | |
| Timing in FIG. 7 | −29%~−36% | −36.5 db |
| | Ave. ΔL ≈ −33% | |

In Table 2, Item refers to the timing scheme; Ave.ΔL refers to the average amount of change in brightness before and after the temperature change; and 90 nitL16 Flicker refers to the flicker parameter when a 16-grayscale screen at 90 nit brightness is displayed, in units of decibel (db). It can be seen by comparing Table 1 and Table 2 that by improving the timings, the brightness difference caused by the temperature change can be reduced, and at the same time, the flicker phenomenon can be ameliorated.

Optionally, FIG. 9 to FIG. 11 further show the comparison data of the x-color coordinate, the comparison data of the y-color coordinate, and the comparison data of the brightness L for a 2-nit display screen under different grayscales when the temperature rises from the normal temperature 25° C. to 50° C. in the timing shown in FIG. 4 and the timing in the related art. The horizontal coordinates all refer to the grayscale, and the vertical coordinates all refer to the amplitude of change and specifically refer to the decrease amplitude/%. As can be seen from FIG. 9 to FIG. 11, when the timing according to the embodiments of the present disclosure is adopted, the decrease amplitude is reduced, i.e., the difference before and after the temperature increase is smaller, and thus the display effect is better. It should be noted that what is improved according to the embodiments of the present disclosure may be the brightness of the first frame of the display screen.

Since the driving method may basically be implemented in the same way and achieve the same technical effects as the pixel circuit described in the foregoing embodiments, the implementations and technical effects of the driving method are not repeated herein for the purpose of brevity.

FIG. 12 is a schematic structural diagram of a display panel according to an embodiment of the present disclosure. As shown in FIG. 12, the display panel includes a substrate 10 and a plurality of pixels P1 disposed on the substrate.

Referring to FIG. 1, the pixel P1 includes a light-emitting element L1 and a pixel circuit. The pixel circuit is coupled to the light-emitting element L1 and is configured to drive the light-emitting element L1 to emit light.

Optionally, in the embodiment of the present disclosure, the display panel further includes a plurality of groups of gate driver on array (GOA) circuits in one-to-one correspondence to a first gate control terminal Gate_N(n), a second gate control terminal Gate_P(n), a first reset terminal Reset_P(n), a second reset terminal Reset_H(n), and a light-emitting control terminal EM(n) coupled to the pixel circuit.

Each group of GOA circuits are coupled to a switch-on signal terminal STV, a clock signal terminal CK/CB and corresponding signal terminals, and are configured to transmit signals to the corresponding signal terminals based on a switch-on signal provided by the switch-on signal terminal and a clock signal provided by the clock signal terminal in accordance with the driving method as described in the foregoing embodiments, i.e., output signals satisfying the timing shown in any one of FIG. 4 to FIG. 7.

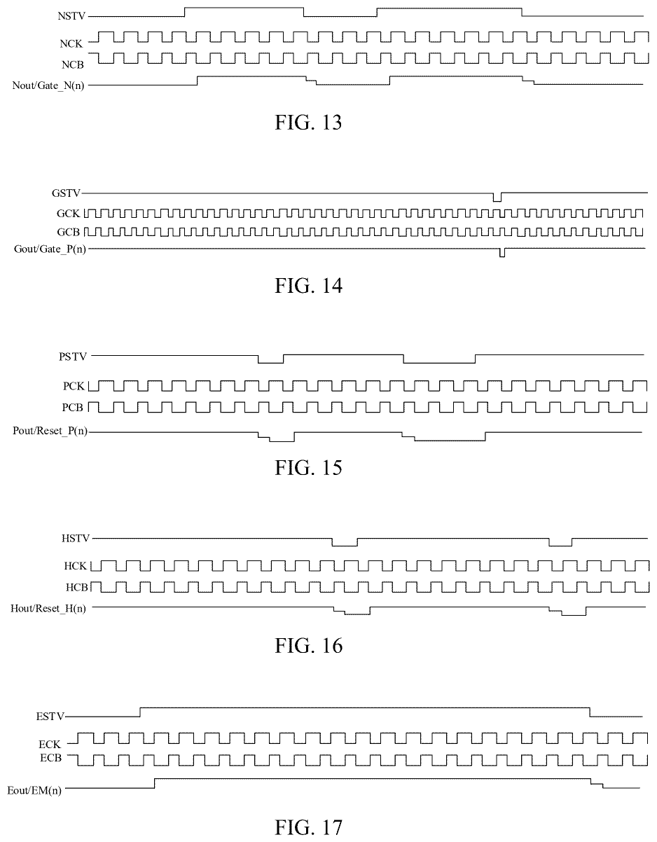

Exemplarily, as can be seen from the signal timing diagram of a GOA circuit corresponding to the first gate control terminal provided in FIG. 13, the GOA circuit corresponding to the first gate control terminal Gate_N(n) is coupled to a switch-on signal terminal NSTV and a clock signal terminal NCK/NCB, and is coupled to the first gate control terminal Gate_N(n) by means of an output terminal Nout, so as to transmit the signal as shown in any one of FIG. 4 to FIG. 7 to the first gate control terminal Gate_N(n).

As can be seen from the signal timing diagram of a GOA circuit corresponding to the second gate control terminal provided in FIG. 14, the GOA circuit corresponding to the second gate control terminal Gate_P(n) is coupled to a switch-on signal terminal GSTV and a clock signal terminal GCK/GCB, and is coupled to the second gate control terminal Gate_P(n) by means of an output terminal Gout, so as to output the signal as shown in any one of FIG. 4 to FIG. 7 to the second gate control terminal Gate_P(n).

As can be seen from the signal timing diagram of a GOA circuit corresponding to the first reset terminal provided in FIG. 15, the GOA circuit corresponding to the first reset terminal Reset_P(n) is coupled to a switch-on signal terminal PSTV and a clock signal terminal PCK/PCB, and is coupled to the first reset terminal Reset_P(n) by means of an output terminal Pout, so as to output the signal as shown in any one of FIG. 4 to FIG. 7 to the first reset terminal Reset_P(n).

As can be seen from the signal timing diagram of a GOA circuit corresponding to the second reset terminal provided in FIG. 16, the GOA circuit corresponding to the second reset terminal Reset_H(n) is coupled to a switch-on signal terminal HSTV and a clock signal terminal HCK/HCB, and is coupled to the second reset terminal Reset_H(n) by means of an output terminal Hout, so as to output the signal as shown in any one of FIG. 4 to FIG. 7 to the second reset terminal Reset_H(n).

As can be seen from the signal timing diagram of a GOA circuit corresponding to the light-emitting control terminal provided in FIG. 17, the GOA circuit corresponding to the light-emitting control terminal EM(n) is coupled to a switch-on signal terminal ESTV and a clock signal terminal ECK/ECB, and is coupled to the light-emitting control terminal EM(n) by means of an output terminal Eout, so as to output the signal as shown in any of FIG. 4 to FIG. 7 to the light-emitting control terminal EM(n).

Additionally, taking the timing shown in FIG. 4 as an example, and in conjunction with FIG. 13, for the first gate control terminal Gate_N(n) which is provided with the first gate control signal at the effective potential (i.e., the high potential) and the first gate control signal at the ineffective potential (i.e., the low potential) sequentially in the two periods, the switch-on signal terminal NSTV coupled to the GOA circuit corresponding to the first gate control terminal Gate_N(n) outputs the switch-on signal at the high potential twice in the refresh frame.

Similarly, as can be seen in conjunction with FIG. 14, in the refresh frame, the low-potential switch-on signal output by the switch-on signal terminal GSTV coupled to the GOA circuit corresponding to the second gate control terminal Gate_P(n) wraps around the low potentials of the clock signals provided by one row of clock signal terminals GCK, so that the switch-on signal terminal GSTV outputs, via the output terminal OUT, the second gate control signal at the effective potential (i.e., the low potential) once to the second gate control terminal Gate_P(n).

As can be seen in conjunction with FIG. 15, in the refresh frame, the switch-on signal terminal PSTV coupled to the GOA circuit corresponding to the first reset terminal Reset_P(n) outputs the switch-on signal at the low potential twice, so as to output, via the output terminal Pout, the first reset signal at the effective potential (i.e., the low potential) twice to the first reset terminal Reset_P.

As can be seen in conjunction with FIG. 16, in the refresh frame, the switch-on signal terminal HSTV coupled to the GOA circuit corresponding to the second reset terminal Reset_H(n) outputs the switch-on signal at the low potential twice, so as to output, via the output terminal Hout, the second reset signal at the effective potential (i.e., the low potentials) twice to the second reset terminal Reset_H(n).

As can be seen in conjunction with FIG. 17, in the refresh frame, the switch-on signal terminal ESTV coupled to the GOA circuit corresponding to the light-emitting control terminal EM(n) outputs the switch-on signal at the high potential once, so as to output, via the output terminal Eout, the light-emitting control signal at the ineffective potential (i.e., the high potential) once to the light-emitting control terminal EM(n).

Herein, the GOA circuits are generally disposed on the substrate 10 of the display panel and are parts of the display panel. Certainly, in some other embodiments, the GOA circuits may also be independent of the display panel.

Since the display panel has basically the same implementations and technical effects as the pixel circuit and the driving method thereof described in the foregoing embodiments, the implementation and technical effects of the display panel are not repeated herein for the purpose of brevity.

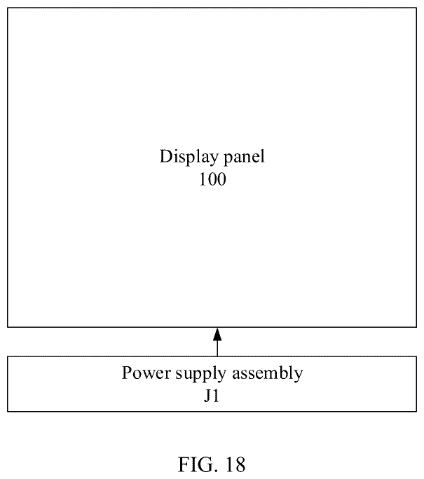

FIG. 18 is a schematic structural diagram of a display device according to an embodiment of the present disclosure. As shown in FIG. 18, the display device includes a power supply assembly J1, and the display panel 100 as shown in FIG. 12.

The power supply assembly J1 is coupled to the display panel 100, and is configured to supply power to the display panel 100.

Optionally, the display device is an OLED display device, an active-matrix organic light-emitting diode (AMOLED) display device, or the like. The OLED display technology is now widely recognized in the market because of its advantages such as high resolution and high contrast.

Optionally, the display device may also be any other product or component having a display function such as a mobile phone, a tablet computer, a flexible display device, a television and a display.

Since the display device has basically the same technical effects as the display panel described in the foregoing embodiments, the technical effect of the display device is not repeated herein for the purpose of brevity.

It should be understood that the terms used in the embodiments of the present disclosure are used only for the purpose of explaining the embodiments but not intended to limit the present disclosure. Unless otherwise defined, the technical or scientific terms used in the embodiments of the present disclosure should have the ordinary meaning understood by persons of ordinary skill in the art to which the present disclosure belongs.

For example, the words “first”, “second”, “third” and the like used in the specification and claims of the present disclosure do not indicate any order, quantity, or importance, but are only used to distinguish between different components.

When an element is referred to be “connected” or “coupled” to another element, the element may be directly connected or coupled to the other element, or there may be an intermediate element. In addition, “connecting” or “coupling” as used herein includes wireless connecting or wireless coupling.

Similarly, similar terms such as “one” and “a/an” do not indicate a limitation of quantity, but rather indicate the existence of at least one.

Similar terms such as “including” and “comprising” mean that the element or object appearing before “including” or “comprising” encompasses the element(s) or object(s) listed after “including” or “comprising” and equivalents thereof, without excluding other elements or objects.

The terms “up”, “down”, “left” or “right” are only used to indicate relative positional relationships. When the absolute position of the described object is changed, the relative positional relationship may be changed accordingly.

Described above are merely optional embodiments of the present disclosure, and are not intended to limit the present disclosure. Any modifications, equivalent substitutions, improvements and the like made within the spirit and principles of the present disclosure should be included in the protection scope of the present disclosure.

1. A pixel circuit, configured to drive a light-emitting element to emit light in a plurality of frame periods which has a target refresh frequency, each of the frame periods comprising a refresh frame and at least one hold frame; the pixel circuit comprising:
a first control circuit, respectively coupled to a first gate control terminal, a second gate control terminal, a data terminal, a first node, a second node, and a third node, wherein the first control circuit is configured to control switching on and off of a connection between the first node and the third node in response to a first gate control signal provided by the first gate control terminal, and configured to control switching on and off of a connection between the data terminal and the second node in response to a second gate control signal provided by the second gate control terminal;
a second control circuit, respectively coupled to a first reset terminal, a second reset terminal, a first initial terminal, a second initial terminal, a third initial terminal, the second node, the third node, and a fourth node, wherein second control circuit is configured to control switching on and off of a connection between the first initial terminal and the third node in response to a first reset signal provided by the first reset terminal, and control switching on and off of a connection between the second initial terminal and the fourth node and control switching on and off of a connection between the third initial terminal and the second node in response to a second reset signal provided by the second reset terminal;
a third control circuit, respectively coupled to a light-emitting control terminal, a driving power supply terminal, the second node, the third node, and the fourth node, wherein the third control circuit is configured to control switching on and off of a connection between the driving power supply terminal and the second node and switching on and off of a connection between the third node and the fourth node in response to a light-emitting control signal provided by the light-emitting control terminal, the fourth node being coupled to the light-emitting element; and
a driving circuit, respectively coupled to the first node, the second node, and the third node, wherein the driving circuit is configured to transmit a driving signal to the third node based on a potential of the first node and a potential of the second node;
wherein the connection between the first initial terminal and the first node and the connection between the third initial terminal and the third node are sequentially controlled to be switched on in the refresh frame, so that a first initial signal and a third initial signal are sequentially transmitted to the first node and the second node through the first initial terminal and the third initial terminal, respectively, wherein a potential difference between the first initial signal and the third initial signal that are transmitted is greater than or equal to a potential difference threshold.

2. The pixel circuit according to claim 1, wherein the potential difference threshold is −9V.

3. The pixel circuit according to claim 1, wherein the first control circuit comprises: a first transistor and a second transistor; the second control circuit comprises: a third transistor, a fourth transistor, and a fifth transistor; the third control circuit comprises: a sixth transistor and a seventh transistor; and the driving circuit comprises: an eighth transistor; wherein
a gate of the first transistor is coupled to the first gate control terminal, a first electrode of the first transistor is coupled to the third node, and a second electrode of the first transistor is coupled to the first node;
a gate of the second transistor is coupled to the second gate control terminal, a first electrode of the second transistor is coupled to the data terminal, and a second electrode of the second transistor is coupled to the second node;
a gate of the third transistor is coupled to the first reset terminal, a first electrode of the third transistor is coupled to the first initial terminal, and a second electrode of the third transistor is coupled to the third node;
a gate of the fourth transistor is coupled to the second reset terminal, a first electrode of the fourth transistor coupled to the second initial terminal, and a second electrode of the fourth transistor is coupled to the fourth node;
a gate of the fifth transistor is coupled to the second reset terminal, a first electrode of the fifth transistor is coupled to the third initial terminal, and a second electrode of the fifth transistor is coupled to the second node;
a gate of the sixth transistor is coupled to the light-emitting control terminal, a first electrode of the sixth transistor is coupled to the driving power supply terminal, and a second electrode of the sixth transistor is coupled to the second node;
a gate of the seventh transistor is coupled to the light-emitting control terminal, a first electrode of the seventh transistor is coupled to the third node, and a second electrode of the seventh transistor is coupled to the fourth node;
a gate of the eighth transistor is coupled to the first node, a first electrode of the eighth transistor is coupled to the second node, and a second electrode of the eighth transistor is coupled to the third node;
the pixel circuit further comprising: a storage capacitor connected between the driving power supply terminal and the first node.

4. The pixel circuit according to claim 3, wherein the first transistor is an N-type transistor; and each of the second transistor, the third transistor, the fourth transistor, the fifth transistor, the sixth transistor, the seventh transistor, the eighth transistor is a P-type transistor; wherein
a material of the N-type transistor comprises an oxide material; and a material of the P-type transistor comprises a low temperature poly-silicon material.

5. A driving method for a pixel circuit, applicable to driving the pixel circuit according to claim 1; the method comprising: sequentially performing a refresh frame and at least one hold frame in each of a plurality of frame periods which has a target refresh frequency; wherein
in the refresh frame, a light-emitting control signal at an effective potential and a light-emitting control signal at an ineffective potential are sequentially provided to a light-emitting control terminal; a first gate control signal at the effective potential and a first gate control signal at the ineffective potential are sequentially provided to a first gate control terminal in at least one period, wherein the first gate control signal at the effective potential is within duration when the light-emitting control signal is at the ineffective potential; and a first reset signal at the effective potential and a second gate control signal at the effective potential are respectively provided to a first reset terminal and a second gate control terminal and a second reset signal at the ineffective potential is provided to a second reset terminal in duration when the first gate control signal is at the effective potential; and a first reset signal at the ineffective potential and a second gate control signal at the ineffective potential are respectively provided to the first reset terminal and the second gate control terminal and a second reset signal at the effective potential is provided to the second reset terminal in duration when the first gate control signal is at the ineffective potential;
in each of the at least one hold frame, a light-emitting control signal at the effective potential and a light-emitting control signal at the ineffective potential are sequentially provided to the light-emitting control terminal;
wherein, for any one of the light-emitting control signals, the first gate control signal, the second gate control signal, the first reset signal, and the second reset signal, the signal at the effective potential is used for controlling a connection between coupled portions to be switched on, and the signal at the ineffective potential is used for controlling the connection between coupled portions to be switched off.

6. The method according to claim 5, wherein
sequentially providing the first gate control signal at the effective potential and the first gate control signal at the ineffective potential to the first gate control terminal in the at least one period comprises:
sequentially providing the first gate control signal at the effective potential and the first gate control signal at the ineffective potential to the first gate control terminal in two periods;
providing the second gate control signal at the effective potential to the second gate control terminal in the duration when the first gate control signal is at the effective potential comprises:
providing the second gate control signal at the effective potential to the second gate control terminal in the duration when the first gate control signal is at the effective potential and in a second period of the two periods;
the method further comprises:
before a first period of the two periods in the refresh frame, providing the light-emitting control signal at the ineffective potential to the light-emitting control terminal, providing the first gate control signal at the ineffective potential to the first gate control terminal, providing the first reset signal at the ineffective potential to the first reset terminal, providing the second gate control signal at the ineffective potential to the second gate control terminal, and providing the second reset signal at the ineffective potential to the second reset terminal.

7. The method according to claim 6, wherein a length of time when the first reset signal is at the effective potential in the second period is greater than or equal to a length of time when the first reset signal is at the effective potential in the second period.

8. The method according to claim 6, wherein a length of time when the first gate control signal is at the ineffective potential and the second reset signal is at the effective potential in the first period is smaller than or equal to a length of time when the first gate control signal is at the ineffective potential and the second reset signal is at the effective potential in the second period.

9. The method according to claim 5, wherein
sequentially providing the first gate control signal at the effective potential and the first gate control signal at the ineffective potential to the first gate control terminal in the at least one period comprises:
sequentially providing the first gate control signal at the effective potential and the first gate control signal at the ineffective potential to the first gate control terminal in one period;
the method further comprises:
before the one period in the refresh frame, providing the light-emitting control signal at the ineffective potential to the light-emitting control terminal, providing the first gate control signal at the ineffective potential to the first gate control terminal, providing the first reset signal at the ineffective potential to the first reset terminal, providing the second gate control signal at the ineffective potential to the second gate control terminal, and providing the second reset signal at the effective potential to the second reset terminal;
wherein a length of time when the second reset signal is at the effective potential before the one period is greater than a length of time when the second reset signal is at the effective potential in the one period.

10. The method according to claim 9, wherein the length of time when the second reset signal is at the effective potential before the one period is equal to a length of time when the first gate control signal is at the effective potential in the one period.

11. The method according to claim 5, further comprising:
in each of the at least one hold frame, providing the first gate control signal at the ineffective potential to the first gate control terminal, providing the first reset signal at the ineffective potential to the first reset terminal, providing the second gate control signal at the ineffective potential to the second gate control terminal, and sequentially providing the second reset signal at the effective potential and the second reset signal at the ineffective potential to the second reset terminal in at least one period, wherein the second reset signal at the effective potential is within the duration when the light-emitting control signal is at the ineffective potential.

12. The method according to claim 5, wherein the target refresh frequency comprises: 120 Hz; and the method comprises: sequentially performing the refresh frame and two hold frames in each of the frame periods.

13. A display panel, comprising: a substrate and a plurality of pixels disposed on the substrate; wherein
each of the plurality of pixels comprises: a light-emitting element, and the pixel circuit according to claim 1, wherein the pixel circuit is coupled to the light-emitting element, and is configured to drive the light-emitting element to emit light.

14. The display panel according to claim 13, further comprising: a plurality of groups of gate driver on array circuits in one-to-one correspondence with a first gate control terminal, a second gate control terminal, a first reset terminal, a second reset terminal, and a light-emitting control terminal that are coupled to the pixel circuit; wherein
each group of GOA circuits is coupled to a switch-on signal terminal, a clock signal terminal, and a corresponding signal terminal which is one of a first gate control terminal, a second gate control terminal, a first reset terminal, a second reset terminal, and a light-emitting control terminal, and is configured to transmit a signal to the corresponding signal terminal based on a switch-on signal provided by the switch-on signal terminal and a clock signal provided by the clock signal terminal according to the driving method which is applicable to driving the pixel circuit; and the method comprises: sequentially performing a refresh frame and at least one hold frame in each of a plurality of frame periods which has a target refresh frequency; wherein
in the refresh frame, a light-emitting control signal at an effective potential and a light-emitting control signal at an ineffective potential are sequentially provided to a light-emitting control terminal; a first gate control signal at the effective potential and a first gate control signal at the ineffective potential are sequentially provided to a first gate control terminal in at least one period, wherein the first gate control signal at the effective potential is within duration when the light-emitting control signal is at the ineffective potential; and a first reset signal at the effective potential and a second gate control signal at the effective potential are respectively provided to a first reset terminal and a second gate control terminal and a second reset signal at the ineffective potential is provided to a second reset terminal in duration when the first gate control signal is at the effective potential; and a first reset signal at the ineffective potential and a second gate control signal at the ineffective potential are respectively provided to the first reset terminal and the second gate control terminal and a second reset signal at the effective potential is provided to the second reset terminal in duration when the first gate control signal is at the ineffective potential;
in each of the at least one hold frame, a light-emitting control signal at the effective potential and a light-emitting control signal at the ineffective potential are sequentially provided to the light-emitting control terminal;
wherein, for any one of the light-emitting control signals, the first gate control signal, the second gate control signal, the first reset signal, and the second reset signal, the signal at the effective potential is used for controlling a connection between coupled portions to be switched on, and the signal at the ineffective potential is used for controlling the connection between coupled portions to be switched off.

15. A display device, comprising: a power supply assembly, and the display panel according to claim 13; wherein
the power supply assembly is coupled to the display panel, and is configured to supply power to the display panel.

16. The display device according to claim 15, wherein the potential difference threshold is −9V.

17. The display device according to claim 15, wherein the first control circuit comprises: a first transistor and a second transistor; the second control circuit comprises: a third transistor, a fourth transistor, and a fifth transistor; the third control circuit comprises: a sixth transistor and a seventh transistor; and the driving circuit comprises: an eighth transistor; wherein
a gate of the first transistor is coupled to the first gate control terminal, a first electrode of the first transistor is coupled to the third node, and a second electrode of the first transistor is coupled to the first node;
a gate of the second transistor is coupled to the second gate control terminal, a first electrode of the second transistor is coupled to the data terminal, and a second electrode of the second transistor is coupled to the second node;
a gate of the third transistor is coupled to the first reset terminal, a first electrode of the third transistor is coupled to the first initial terminal, and a second electrode of the third transistor is coupled to the third node;
a gate of the fourth transistor is coupled to the second reset terminal, a first electrode of the fourth transistor coupled to the second initial terminal, and a second electrode of the fourth transistor is coupled to the fourth node;
a gate of the fifth transistor is coupled to the second reset terminal, a first electrode of the fifth transistor is coupled to the third initial terminal, and a second electrode of the fifth transistor is coupled to the second node;
a gate of the sixth transistor is coupled to the light-emitting control terminal, a first electrode of the sixth transistor is coupled to the driving power supply terminal, and a second electrode of the sixth transistor is coupled to the second node;
a gate of the seventh transistor is coupled to the light-emitting control terminal, a first electrode of the seventh transistor is coupled to the third node, and a second electrode of the seventh transistor is coupled to the fourth node;
a gate of the eighth transistor is coupled to the first node, a first electrode of the eighth transistor is coupled to the second node, and a second electrode of the eighth transistor is coupled to the third node;
the pixel circuit further comprising: a storage capacitor connected between the driving power supply terminal and the first node.

18. The display device according to claim 17, wherein the first transistor is an N-type transistor; and each of the second transistor, the third transistor, the fourth transistor, the fifth transistor, the sixth transistor, the seventh transistor, the eighth transistor is a P-type transistor; wherein
a material of the N-type transistor comprises an oxide material; and a material of the P-type transistor comprises a low temperature poly-silicon material.

19. The display device according to claim 15, wherein the display panel further comprises: a plurality of groups of gate driver on array circuits in one-to-one correspondence with a first gate control terminal, a second gate control terminal, a first reset terminal, a second reset terminal, and a light-emitting control terminal that are coupled to the pixel circuit; wherein
each group of GOA circuits is coupled to a switch-on signal terminal, a clock signal terminal, and a corresponding signal terminal which is one of a first gate control terminal, a second gate control terminal, a first reset terminal, a second reset terminal, and a light-emitting control terminal, and is configured to transmit a signal to the corresponding signal terminal based on a switch-on signal provided by the switch-on signal terminal and a clock signal provided by the clock signal terminal according to a driving method which is applicable to driving the pixel circuit; and the method comprises: sequentially performing a refresh frame and at least one hold frame in each of a plurality of frame periods which has a target refresh frequency; wherein
in the refresh frame, a light-emitting control signal at an effective potential and a light-emitting control signal at an ineffective potential are sequentially provided to a light-emitting control terminal; a first gate control signal at the effective potential and a first gate control signal at the ineffective potential are sequentially provided to a first gate control terminal in at least one period, wherein the first gate control signal at the effective potential is within duration when the light-emitting control signal is at the ineffective potential; and a first reset signal at the effective potential and a second gate control signal at the effective potential are respectively provided to a first reset terminal and a second gate control terminal and a second reset signal at the ineffective potential is provided to a second reset terminal in duration when the first gate control signal is at the effective potential; and a first reset signal at the ineffective potential and a second gate control signal at the ineffective potential are respectively provided to the first reset terminal and the second gate control terminal and a second reset signal at the effective potential is provided to the second reset terminal in duration when the first gate control signal is at the ineffective potential;
in each of the at least one hold frame, a light-emitting control signal at the effective potential and a light-emitting control signal at the ineffective potential are sequentially provided to the light-emitting control terminal;
wherein, for any one of the light-emitting control signals, the first gate control signal, the second gate control signal, the first reset signal, and the second reset signal, the signal at the effective potential is used for controlling a connection between coupled portions to be switched on, and the signal at the ineffective potential is used for controlling the connection between coupled portions to be switched off.

20. The display panel according to claim 13, wherein the first control circuit comprises: a first transistor and a second transistor; the second control circuit comprises: a third transistor, a fourth transistor, and a fifth transistor; the third control circuit comprises: a sixth transistor and a seventh transistor; and the driving circuit comprises: an eighth transistor; wherein
a gate of the first transistor is coupled to the first gate control terminal, a first electrode of the first transistor is coupled to the third node, and a second electrode of the first transistor is coupled to the first node;
a gate of the second transistor is coupled to the second gate control terminal, a first electrode of the second transistor is coupled to the data terminal, and a second electrode of the second transistor is coupled to the second node;
a gate of the third transistor is coupled to the first reset terminal, a first electrode of the third transistor is coupled to the first initial terminal, and a second electrode of the third transistor is coupled to the third node;
a gate of the fourth transistor is coupled to the second reset terminal, a first electrode of the fourth transistor coupled to the second initial terminal, and a second electrode of the fourth transistor is coupled to the fourth node;
a gate of the fifth transistor is coupled to the second reset terminal, a first electrode of the fifth transistor is coupled to the third initial terminal, and a second electrode of the fifth transistor is coupled to the second node;
a gate of the sixth transistor is coupled to the light-emitting control terminal, a first electrode of the sixth transistor is coupled to the driving power supply terminal, and a second electrode of the sixth transistor is coupled to the second node;
a gate of the seventh transistor is coupled to the light-emitting control terminal, a first electrode of the seventh transistor is coupled to the third node, and a second electrode of the seventh transistor is coupled to the fourth node;
a gate of the eighth transistor is coupled to the first node, a first electrode of the eighth transistor is coupled to the second node, and a second electrode of the eighth transistor is coupled to the third node;
the pixel circuit further comprising: a storage capacitor connected between the driving power supply terminal and the first node.
